(19) United States
(12) Patent Application Publication
(10) Pub. No.: US 2026/0138373 A1
(43) Pub. Date: May 21, 2026

(54) LIQUID ACCOMMODATION BODY AND LIQUID EJECTION DEVICE

(71) Applicant: SEIKO EPSON CORPORATION, Tokyo (JP)

(72) Inventor: Satoshi INOMATA, MATSUMOTO-SHI (JP)

(21) Appl. No.: 19/391,222

(22) Filed: Nov. 17, 2025

(30) Foreign Application Priority Data
Nov. 20, 2024 (JP) 2024-202167

(51) Int. Cl. B41J 2/175; G01F 23/38

(52) U.S. Cl. CPC B41J 2/17566; B41J 2/17513; G01F 23/38; B41J 2002/17576

(57) ABSTRACT

The liquid accommodation body includes a liquid accommodation section that accommodates a liquid, a float section that is provided in the liquid accommodation section and floats on the liquid accommodated in the liquid accommodation section to be displaced in a vertical direction, a first magnetic body that is provided in the liquid accommodation section and moves linked with displacement of the float section in the vertical direction, a second magnetic body that is provided outside the liquid accommodation section and moves linked with displacement of the first magnetic body in the vertical direction, and a sensor that is provided outside the liquid accommodation section and detects a value corresponding to a liquid level of the liquid accommodated in the liquid accommodation section linked with displacement of the second magnetic body in the vertical direction.

The present application is based on, and claims priority from JP Application Serial Number 2024-202167, filed November 20, 2024, the disclosure of which is hereby incorporated by reference herein in its entirety.

### BACKGROUND

### 1. Technical Field

The present disclosure relates to a liquid accommodation body and a liquid ejection device.

### 2. Related Art

For example, JP-A-6-270410 discloses an ink tank accommodating a water-soluble ink as an example of a liquid, and an inkjet printer that performs printing with the water-soluble ink supplied from the ink tank. In such an inkjet printer, a liquid level of the ink tank is detected from the presence or absence of energization between a plurality of electrodes in the ink tank, which is an example of a liquid accommodation body.

However, in such a liquid accommodation body, although it is possible to detect whether or not the liquid level accommodated in the liquid accommodation body is a predetermined liquid level, the liquid level cannot be detected in a plurality of stages.

### SUMMARY

A liquid accommodation body includes a liquid accommodation section configured to accommodate liquid; a float section that is provided in the liquid accommodation section and that is configured to be displaced in a vertical direction by floating in the liquid accommodated in the liquid accommodation section; a first magnetic body that is provided in the liquid accommodation section and that is configured to move linked with displacement of the float section in the vertical direction; a second magnetic body that is provided outside the liquid accommodation section and that is configured to move linked with displacement of the first magnetic body in the vertical direction; and a sensor that is provided outside the liquid accommodation section and that is configured to detect a value corresponding to a liquid level of the liquid accommodated in the liquid accommodation section according to displacement of the second magnetic body in the vertical direction.

A liquid ejection device that solves the above problem configured to detect a liquid level of liquid accommodated in a liquid accommodation body including a liquid accommodation section configured to accommodate the liquid, a float section configured to be displaced in a vertical direction by floating in the liquid accommodated in the liquid accommodation section, and a first magnetic body configured to move linked with displacement of the float section in the vertical direction, the liquid ejection device includes a liquid ejection section configured to eject the liquid accommodated in the liquid accommodation body; a second magnetic body configured to move linked with displacement of the first magnetic body in the vertical direction; a sensor configured to detect a value corresponding to the liquid level of the liquid accommodated in the liquid accommodation body according to displacement of the second magnetic body in the vertical direction; and a control section configured to calculate the liquid level of the liquid accommodated in the liquid accommodation section based on a detection result of the sensor.

### BRIEF DESCRIPTION OF THE DRAWINGS

FIG. 1 is a schematic diagram illustrating a liquid ejection device according to a first embodiment.

FIG. 2 is a perspective view illustrating a liquid accommodation body of the first embodiment.

FIG. 3 is a perspective view illustrating a float section of the first embodiment.

FIG. 4 is a cross-sectional perspective view illustrating the float section of the first embodiment.

FIG. 5 is a front view illustrating the liquid accommodation body of the first embodiment.

FIG. 6 is a front view illustrating the liquid accommodation body of the first embodiment.

FIG. 7 is a graph showing a relationship between an angle of a link member and a liquid level in the first embodiment.

FIG. 8 is a circuit diagram of a sensor according to a second embodiment.

FIG. 9 is a cross-sectional perspective view illustrating the float section of a third embodiment.

### DESCRIPTION OF EMBODIMENTS

### FIRST EMBODIMENT

Hereinafter, an embodiment of a liquid ejection device including a liquid accommodation body will be described with reference to the drawings. In the following description, in a state where a liquid ejection device is installed on a horizontal surface, an axis intersecting the horizontal surface is referred to as a Z-axis, an axis intersecting the Z-axis is referred to as an X-axis, and an axis intersecting the X-axis and the Z-axis is referred to as a Y-axis. One direction along the X-axis is defined as a first width direction X1, and the other direction along the X-axis is defined as a second width direction X2. One direction along the Y-axis is defined as a front direction Y1, and the other direction along the Y-axis is defined as a rear direction Y2. An upper direction along the Z-axis is defined as an upper direction Z1, and a lower direction along the Z-axis is defined as a lower direction Z2. The direction along the Z-axis is an example of a vertical direction. Viewing from the upper direction Z1 is simply referred to as a top view. Viewing from the front direction Y1 is simply referred to as a front view.

### Configuration of liquid ejection device 11

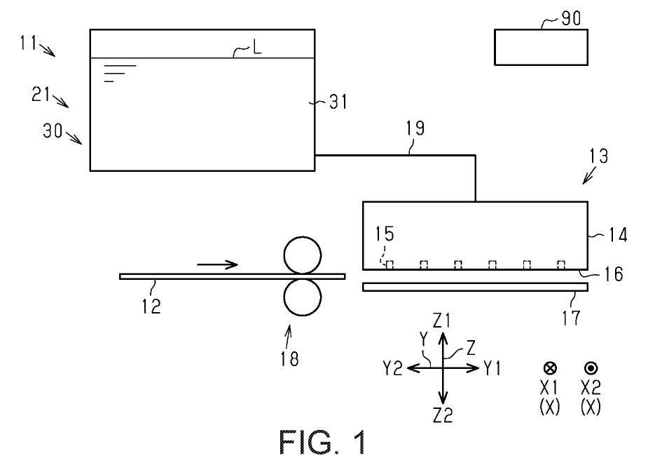

As illustrated in FIG. 1, a liquid ejection device 11 is configured to perform printing by ejecting liquid onto a medium 12. The liquid ejection device 11 may be an inkjet printer that performs printing by ejecting ink, which is an example of the liquid, onto the medium 12. The medium 12 may be, for example, a paper sheet, fabric, vinyl, a plastic part, a metal part, or the like.

The liquid ejection device 11 includes a liquid ejection section 13. The liquid ejection section 13 is configured to eject liquid onto the medium 12. The liquid ejection section 13 includes a head 14. The head 14 ejects liquid onto the medium 12. The head 14 is configured to eject the liquid accommodated in a liquid accommodation body 21 (to be described later). That is, the liquid ejection section 13 is configured to eject the liquid accommodated in the liquid accommodation body 21.

The head 14 includes a nozzle surface 16 in which a plurality of nozzles 15 are open. The nozzle surface 16 may be a surface facing the lower direction Z2. The head 14 performs printing by ejecting liquid from each of the plurality of nozzles 15 onto the medium 12.

The head 14 may be a serial type or a line type. In the serial type, printing is performed by ejecting liquid onto the medium 12 while the head 14 is moving. In the line type, the head 14 is provided to be elongate along the width of the medium 12, and printing is performed by ejecting liquid onto the medium 12.

The liquid ejection device 11 includes a medium support section 17. The medium support section 17 is configured to support the medium 12. The medium support section 17 is provided so as to face the nozzle surface 16. The medium support section 17 is configured so as to support the medium 12 onto which liquid is ejected by the liquid ejection section 13.

The liquid ejection device 11 may include a transport section 18. The transport section 18 is configured to transport the medium 12. The transport section 18 transports the medium 12 from a medium accommodation section (not illustrated) to the head 14. The transport section 18 transports the medium 12 that is printed by the head 14 outside the liquid ejection device 11. The transport section 18 may include a roller.

The liquid ejection device 11 may include a supply flow path 19. The liquid ejection device 11 may include a plurality of supply flow paths 19 corresponding to the colors of liquid. The supply flow path 19 is a flow path for supplying liquid from the liquid accommodation body 21 (to be described later) to the head 14.

An upstream end of the supply flow path 19 is connected to the liquid accommodation body 21. A downstream end of the supply flow path 19 is connected to the head 14. The supply flow path 19 may supply liquid by a water head. The liquid ejection device 11 may include a pump (not illustrated) that supplies liquid from the liquid accommodation body 21 to the head 14.

The liquid ejection device 11 includes the liquid accommodation body 21. The liquid ejection device 11 may include a plurality of liquid accommodation bodies 21 corresponding to the colors of liquid. The liquid accommodation body 21 accommodates liquid to be supplied to the head 14. The liquid accommodation body 21 may be an ink tank. The liquid accommodation body 21 may be fixed to the liquid ejection device 11.

The liquid ejection device 11 includes a control section 90. The control section 90 comprehensively controls the liquid ejection device 11. The control section 90 controls various operations executed by the liquid ejection device 11. The control section 90 may be configured as a circuit including: α: one or more processors that execute various processes according to a computer program; β: one or more dedicated hardware circuits that execute at least some of the various processes; or γ: a combination thereof. The hardware circuit is, for example, an application-specific integrated circuit. The processor includes a CPU and a memory, such as a RAM and a ROM, and the memory stores program code or instructions configured to cause the CPU to execute processes. The memory, that is, a computer readable medium includes any readable medium that can be accessed by a general-purpose or dedicated computer.

The control section 90 displays various types of information on a display section (not illustrated). The control section 90 receives an instruction from a user via an operation section (not illustrated). The liquid ejection device 11 may be capable of communicating with a terminal device (not illustrated). The control section 90 may receive an instruction from the user via the terminal device.

### Configuration of liquid accommodation body 21

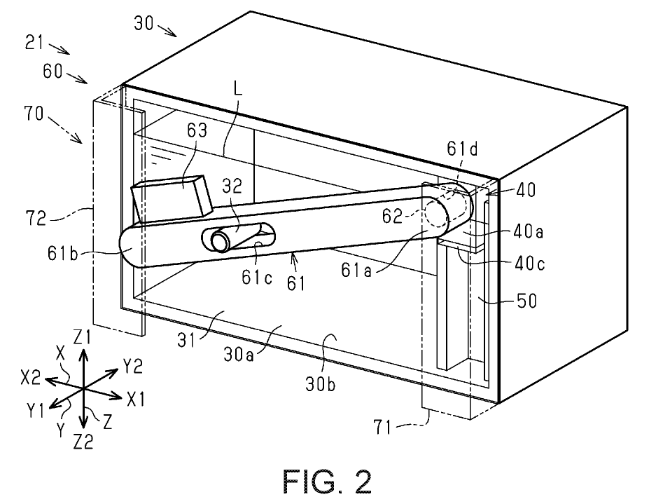

As illustrated in FIG. 2, the liquid accommodation body 21 includes a liquid accommodation section 30, a float section 40, and a guide section 50. The liquid accommodation section 30 accommodates liquid. In particular, the liquid accommodation section 30 accommodates liquid to be supplied to the head 14. The liquid accommodation section 30 may be a container that accommodates liquid. The liquid accommodation section 30 includes a liquid accommodation chamber 31. The liquid accommodation chamber 31 accommodates liquid in the liquid accommodation section 30.

The liquid accommodation section 30 includes an outer side surface 30a and an inner side surface 30b. The outer side surface 30a is a surface facing the outside in the liquid accommodation section 30. The outer side surface 30a includes a surface facing the front direction Y1 on the front direction Y1 side of the liquid accommodation section 30. The inner side surface 30b is a surface facing the inside in the liquid accommodation section 30. The inner side surface 30b includes a surface facing the rear direction Y2 on the front direction Y1 side of the liquid accommodation section 30.

The liquid accommodation section 30 may include a support shaft 32. That is, the liquid accommodation body 21 may include the support shaft 32. The support shaft 32 is provided so as to extend along the front direction Y1. The support shaft 32 may be provided so as to extend from the outer side surface 30a on the front direction Y1 side of the liquid accommodation section 30 to the front direction Y1.

The guide section 50 is provided in the liquid accommodation section 30. The guide section 50 is accommodated in the liquid accommodation chamber 31. The guide section 50 is provided so as to extend along the Z-axis. The guide section 50 contacts the float section 40 from both the first width direction X1 and the second width direction X2. The guide section 50 contacts the float section 40 from the rear direction Y2. The guide section 50 contacts the float section 40 from the rear direction Y2 so that the float section 40 contacts the inner side surface 30b. The guide section 50 guides the float section 40 so as to be displaceable in the direction along the Z-axis. The guide section 50 is not in contact with the inner side surface 30b, but may be in contact with the inner side surface 30b.

The float section 40 is provided in the liquid accommodation section 30. The float section 40 floats on the liquid accommodated in the liquid accommodation section 30. The float section 40 contacts the guide section 50 from both the first width direction X1 and the second width direction X2.

The float section 40 is displaceable in the direction along the Z-axis while being guided by the guide section 50. That is, the float section 40 floats on the liquid accommodated in the liquid accommodation section 30 and is displaced in the direction along the Z-axis.

By this, the float section 40 is displaced in the direction along the Z-axis, linked with a liquid level L of the liquid accommodated in the liquid accommodation section 30. The liquid level L indicates the height of the liquid surface of the liquid accommodated in the liquid accommodation section 30. Hereinafter, the liquid level L of the liquid accommodated in the liquid accommodation section 30 may be simply referred to as the liquid level L.

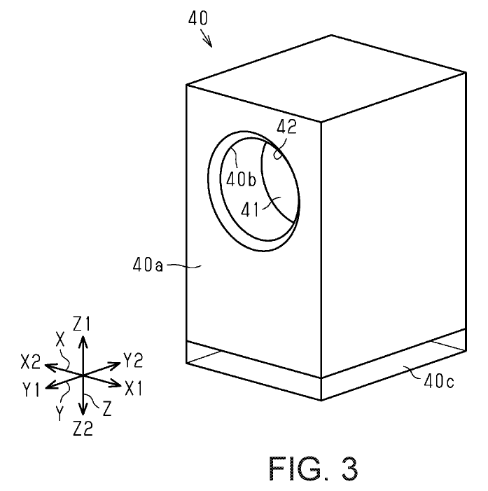

As illustrated in FIG. 3, the float section 40 includes a first surface 40a. The first surface 40a is a front surface of the float section 40. That is, the first surface 40a is a surface on the front direction Y1 side of the float section 40. The first surface 40a may be in contact with the inner side surface 30b.

The float section 40 may include an opening section 40b. The opening section 40b communicates the first surface 40a with a magnetic body accommodation chamber 42 (to be described later). The opening section 40b is provided at a position overlapping the magnetic body accommodation chamber 42 in a front view.

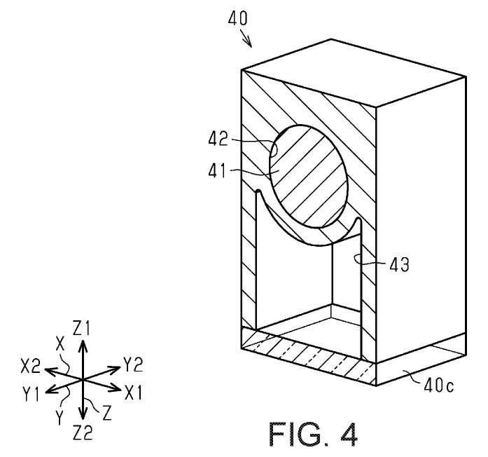

As illustrated in FIG. 4, the liquid accommodation body 21 includes a first magnetic body 41. The float section 40 includes the magnetic body accommodation chamber 42 and an air chamber 43. The magnetic body accommodation chamber 42 is provided in the upper direction Z1 than the air chamber 43. The magnetic body accommodation chamber 42 accommodates the first magnetic body 41. That is, the float section 40 accommodates the first magnetic body 41.

The first magnetic body 41 is provided in the liquid accommodation section 30. The first magnetic body 41 is accommodated in the magnetic body accommodation chamber 42. The first magnetic body 41 may be, for example, a ferromagnetic body such as a magnet. The first magnetic body 41 moves linked with displacement of the float section 40 in the direction along the Z-axis. That is, the first magnetic body 41 is displaced in the direction along the Z-axis, linked with the liquid level L. The first magnetic body 41 may be positioned on the rear direction Y2 than the first surface 40a.

The air chamber 43 is provided inside the float section 40. The air chamber 43 may be provided by cutting out a part of the inside of the float section 40. The air chamber 43 may be sealed from the lower direction Z2 side by a sealing lid 40c.

The air chamber 43 is provided in the lower direction Z2 than the magnetic body accommodation chamber 42. That is, the air chamber 43 is provided in the lower direction Z2 of the first magnetic body 41. The magnetic body accommodation chamber 42 and the air chamber 43 are provided at positions overlapping each other in the top view.

As illustrated in FIG. 2, the liquid accommodation body 21 includes a liquid level detection device 60. The liquid level detection device 60 detects the liquid level L of the liquid accommodated in the liquid accommodation chamber 31. That is, the liquid ejection device 11 detects the liquid level L of the liquid accommodated in the liquid accommodation body 21.

The liquid level detection device 60 includes a link member 61, a second magnetic body 62, a sensor 63, and a link guide section 70. That is, the liquid ejection device 11 and the liquid accommodation body 21 include the link member 61, the second magnetic body 62, the sensor 63, and the link guide section 70.

The link member 61 is configured to extend along the longitudinal direction. The link member 61 may have a flat plate shape. By this, the liquid level detection device 60 is to be made more compact. The link member 61 includes a first end section 61a, a second end section 61b, and an elongated hole 61c. The first end section 61a is an end section on one side in the longitudinal direction of the link member 61. The second end section 61b is an end section the other side in the longitudinal direction of the link member 61. In the present embodiment, the first end section 61a is an end section of the link member 61 on the first width direction X1 side. In the present embodiment, the second end section 61b is an end section of the link member 61 on the second width direction X2 side.

The elongated hole 61c is provided between the first end section 61a and the second end section 61b. The elongated hole 61c is provided on the second end section 61b side than the center of the link member 61, but may be provided at any position. The elongated hole 61c is provided so as to extend in the longitudinal direction of the link member 61. The elongated hole 61c is a hole through which the support shaft 32 can be inserted.

The link member 61 is provided on the outer side surface 30a of the liquid accommodation section 30. The link member 61 is supported by the support shaft 32 in a state where the support shaft 32 is inserted through the elongated hole 61c. The link member 61 is supported by the support shaft 32 so as to extend along the outer side surface 30a.

The link member 61 is provided to be rotatable around the support shaft 32 in a state where the support shaft 32 is inserted through the elongated hole 61c. The link member 61 is provided slidably along the longitudinal direction in a state where the support shaft 32 is inserted into the elongated hole 61c.

The link member 61 includes a holding section 61d. The holding section 61d is provided on the first end section 61a. The holding section 61d is a portion that holds the second magnetic body 62. The holding section 61d may be a recess section that holds the second magnetic body 62.

The second magnetic body 62 is provided outside the liquid accommodation section 30. The second magnetic body 62 is held by the holding section 61d. The second magnetic body 62 is provided at the first end section 61a. The link member 61 may include the second magnetic body 62.

The second magnetic body 62 may be, for example, a ferromagnetic body such as a magnet. The second magnetic body 62 has a polarity that attracts the first magnetic body 41. The second magnetic body 62 is provided at a position facing the first magnetic body 41 with the liquid accommodation section 30 interposed therebetween on the front direction Y1 side of the liquid accommodation section 30. That is, the first end section 61a is provided at a position facing the float section 40 with the liquid accommodation section 30 interposed therebetween on the front direction Y1 side of the liquid accommodation section 30.

The second magnetic body 62 is attracted to the first magnetic body 41, and thus moves linked with displacement of the first magnetic body 41 in the direction along the Z-axis. The link member 61 moves linked with displacement of the first magnetic body 41 in the direction along the Z-axis. That is, the second magnetic body 62 is displaced in the direction along the Z-axis, linked with the liquid level L.

The material of the liquid accommodation section 30 is selected so that the first magnetic body 41 and the second magnetic body 62 attract each other with the liquid accommodation section 30 interposed therebetween. The thickness of the liquid accommodation section 30 is set such that the first magnetic body 41 and the second magnetic body 62 attract each other with the liquid accommodation section 30 interposed therebetween.

The sensor 63 is provided outside the liquid accommodation section 30. The sensor 63 is provided on the second end section 61b. The sensor 63 and the second magnetic body 62 are connected by the link member 61. The sensor 63 detects the angle of the link member 61. The sensor 63 detects the angle of the link member 61 according to the rotation of the link member 61. That is, the sensor 63 detects a value corresponding to the liquid level L.

The output of the sensor 63 changes according to the change in the angle of the link member 61. In the first embodiment, the sensor 63 may be an angle sensor. The sensor 63 may be an acceleration sensor.

The link guide section 70 is a member that guides the link member 61 from the front direction Y1 side. In FIG. 2, the link guide section 70 is indicated by a two dot chain line. The link guide section 70 guides the link member 61 together with the outer side surface 30a on the front direction Y1 side of the liquid accommodation section 30. The link guide section 70 rotatably guides the link member 61 along the outer side surface 30a. The link guide section 70 slidably guides the link member 61 along the outer side surface 30a. The link guide section 70 may guide the link member 61 to the rear direction Y2 so as not to come off it in the front direction Y1 of the support shaft 32.

The link guide section 70 may include a first link guide section 71 and a second link guide section 72. The first link guide section 71 is provided on the first width direction X1 side of the liquid accommodation section 30. The first link guide section 71 may protrude from the outer side surface 30a toward the front direction Y1. The first link guide section 71 is provided so as to guide the first end section 61a from the front direction Y1 side.

The second link guide section 72 is provided on the second width direction X2 side of the liquid accommodation section 30. The second link guide section 72 may be provided from the outer side surface 30a toward the front direction Y1. The second link guide section 72 is provided so as to guide the second end section 61b from the front direction Y1 side.

### Operation of liquid level detection

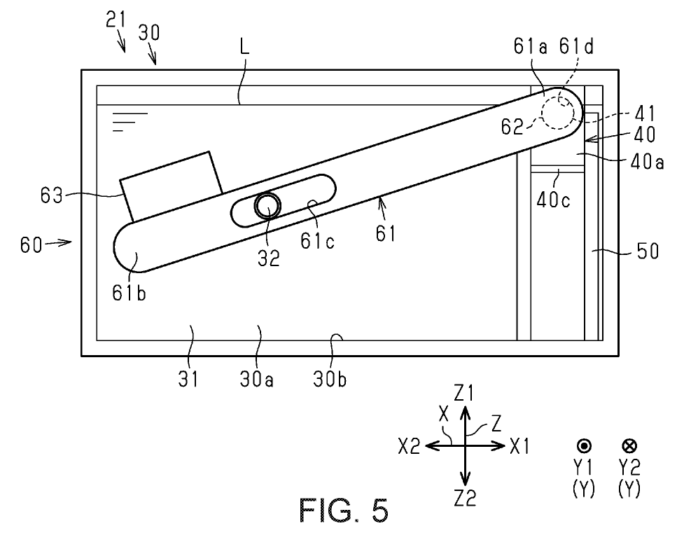

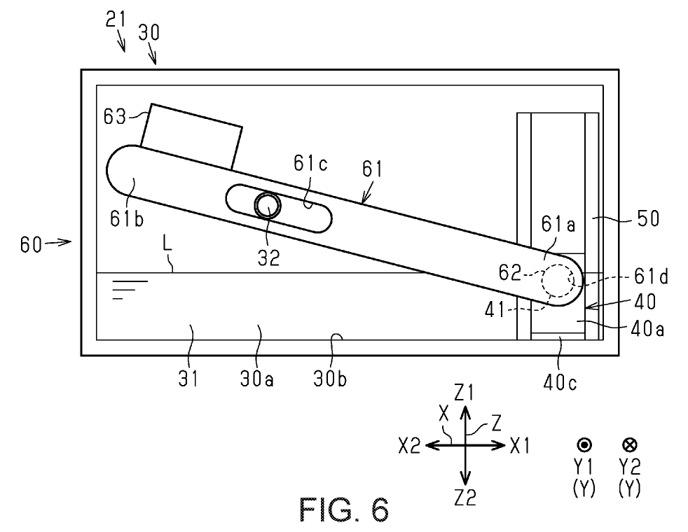

As illustrated in FIG. 5 and FIG. 6, the float section 40 floats in the liquid accommodated in the liquid accommodation section 30. The float section 40 is displaced in the direction along the Z-axis, linked with the liquid level L. The first magnetic body 41 and the second magnetic body 62 attract each other by magnetic force, so that the float section 40 and the first end section 61a are positioned at the same height. That is, the float section 40 and the first end section 61a overlap each other in a front view.

When the liquid accommodated in the liquid accommodation section 30 decreases, the liquid level L lowers. In such a case, the float section 40 is displaced in the lower direction Z2 along the Z-axis, linked with the liquid level L. When the liquid accommodated in the liquid accommodation section 30 increases, the liquid level L rises. In such a case, the float section 40 is displaced in the upper direction Z1 along the Z-axis, linked with the liquid level L.

The first magnetic body 41 and the second magnetic body 62 attract each other by magnetic force, so that the float section 40 and the first end section 61a are positioned at the same height. By this, the link member 61 slides in the longitudinal direction in a state of being supported by the support shaft 32 and rotates around the support shaft 32, according to displacement of the second magnetic body 62 in the direction along the Z-axis. That is, the link member 61 rotates according to displacement of the liquid level L.

In this manner, the angle of the link member 61 changes according to displacement of the second magnetic body 62 in the direction along the Z-axis. That is, the angle of the link member 61 changes according to displacement of the liquid level L.

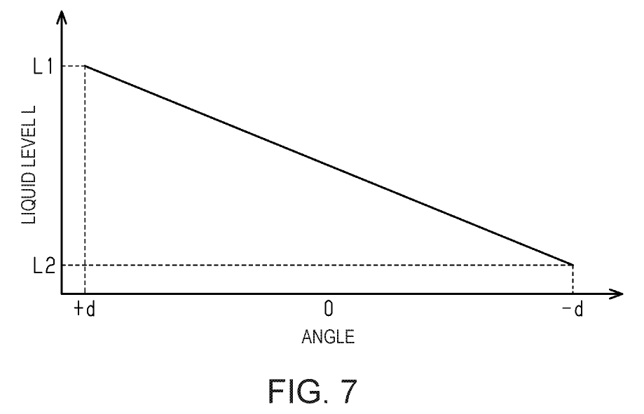

As illustrated in FIG. 7, liquid level detection data is stored in the memory. The liquid level detection data is data indicating a correspondence relationship between the angle of the link member 61 detected by the sensor 63 and the liquid level L.

The liquid level detection data may be data in which the angle of the link member 61 and the liquid level L are proportional to each other. As for the angle of the link member 61, in a front view, the angle at which the first end section 61a is directed toward the first width direction X1 is defined as 0 degrees, the angle at which the first end section 61a is inclined toward the upper direction Z1 is defined as a positive angle, and the angle at which the first end section 61a is inclined toward the lower direction Z2 is defined as a negative angle.

As a specific example, in the liquid level detection data, when the angle of the link member 61 is a positive angle +d, a first liquid level L1 is associated as the liquid level L. In the liquid level detection data, when the angle of the link member 61 is a negative angle -d, a second liquid level L2 is associated as the liquid level L. The first liquid level L1 is higher than the second liquid level L2.

The control section 90 calculates the liquid level L corresponding to the angle of the link member 61 detected by the sensor 63 by referring to the liquid level detection data. As a specific example, when the angle of the link member 61 is the positive angle +d, the control section 90 calculates the first liquid level L1 as the liquid level L. When the angle of the link member 61 is the negative angle -d, the control section 90 calculates the second liquid level L2 as the liquid level L.

In this manner, the control section 90 detects the liquid level L according to the output of the sensor 63. That is, the control section 90 calculates the liquid level L based on the detection result of the sensor 63. In other words, the sensor 63 can detect the liquid level L by detecting the angle of the link member 61 according to displacement of the second magnetic body 62 in the direction along the Z-axis.

The control section 90 may cause a display section (not illustrated) to display the remaining amount of the liquid in the liquid accommodation section 30 based on the detected liquid level L. By this, the control section 90 can notify the remaining amount of the liquid in the liquid accommodation section 30 in a plurality of continuous stages based on the detected liquid level L. When the control section 90 determines that the detected liquid level L is equal to or less than the threshold, the control section 90 may notify the user of information indicating that the liquid in the liquid accommodation section 30 is to be replenished by causing the display section to display the information.

### Operations and effects of first embodiment

Operations and effects of first embodiment will be described.

(1-1) Using the first magnetic body 41 inside the liquid accommodation section 30 and the second magnetic body 62 and the sensor 63 outside the liquid accommodation section 30, the control section 90 is possible to continuously detect displacement of the float section 40 floating on the liquid accommodated in the liquid accommodation section 30 in the direction along the Z-axis.

According to this configuration, the liquid level L can be continuously detected. In addition, the float section 40 and the first magnetic body 41 provided inside the liquid accommodation section 30, and the second magnetic body 62 and the sensor 63 provided outside the liquid accommodation section 30 can have their movement linked together in a non-contact manner. By this, the liquid level L can be continuously detected without providing the sensor 63 in the liquid accommodation section 30. Furthermore, in order to continuously detect the liquid level L, the liquid accommodation body 21 does not need to include a plurality of electrodes having different heights in the liquid accommodation section 30. Therefore, it is possible to improve user convenience.

(1-2) The liquid accommodation body 21 further includes the link member 61 that rotates according to displacement of the second magnetic body 62 in the direction along the Z-axis. According to this configuration, further using the link member 61, the control section 90 continuously detects displacement of the float section 40 floating on the liquid accommodated in the liquid accommodation section 30 in the direction along the Z-axis. By this, it is possible to continuously detect the liquid level L. Therefore, it is possible to improve user convenience.

(1-3) The link member 61 is provided on the outer side surface 30a of the liquid accommodation section 30. According to this configuration, using the link member 61 outside the liquid accommodation section 30, it is possible to continuously detect displacement of the float section 40 floating on the liquid accommodated in the liquid accommodation section 30 in the direction along the Z-axis. By this, it is possible to continuously detect the liquid level L. Therefore, it is possible to improve user convenience.

(1-4) The sensor 63 and the second magnetic body 62 are connected by the link member 61, and the angle of the link member 61 changes according to displacement of the second magnetic body 62 in the direction along the Z-axis. According to this configuration, displacement of the float section 40 in the direction along the Z-axis can be detected based on the angle of the link member 61. By this, the liquid level L can be continuously detected without providing the sensor 63 in the liquid accommodation section 30. Therefore, it is possible to improve user convenience.

(1-5) The float section 40 has the magnetic body accommodation chamber 42 that accommodates the first magnetic body 41 and the air chamber 43 and the magnetic body accommodation chamber 42 and the air chamber 43 are provided at positions that overlapping each other as viewed from the direction along the Z-axis. According to this configuration, with a simple configuration, the float section 40 can float in a more stable state on the liquid accommodated in the liquid accommodation section 30 while the first magnetic body 41 is accommodated. By this, it can increase the certainty that the float section 40 floats on the liquid accommodated in the liquid accommodation section 30. Therefore, the detection accuracy of the liquid level L can be improved.

(1-6) The liquid accommodation section 30 has the guide section 50 that guides the float section 40 so as to be displaceable in the direction along the Z-axis. According to this configuration, it can increase the certainty of displacing the float section 40 in the direction along the Z-axis. By this, the float section 40 can float in a more stable state on the liquid accommodated in the liquid accommodation section 30. Therefore, the detection accuracy of the liquid level L can be improved.

### SECOND EMBODIMENT

Next, a second embodiment will be described. In the following description, redundant descriptions of configurations identical to those of the previously described embodiment will be omitted or simplified, and configurations that differ from the previously described embodiment will be detailed.

### Liquid level detection using variable resistor 81

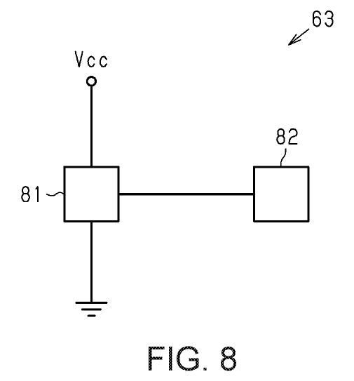

As illustrated in FIG. 8, in the second embodiment, the sensor 63 may include a potentiometer. The sensor 63 may include a variable resistor 81 and a measurement section 82. The variable resistor 81 may be a potentiometer, as an example. The variable resistor 81 and the measurement section 82 are electrically connected to each other.

The link member 61 may not include the elongated hole 61c and may include a rotation shaft (not illustrated). The link member 61 may be rotatable around the rotation shaft. The rotation shaft of the link member 61 is connected to the variable resistor 81.

The resistance value of the variable resistor 81 changes according to the rotation of the link member 61 via the rotation shaft of the link member 61. In other words, the variable resistor 81 is configured such that the resistance value changes according to displacement of the second magnetic body 62 in the direction along the Z-axis.

The measurement section 82 is configured to measure a signal from the variable resistor 81. The measurement section 82 is configured to measure the voltage at the variable resistor 81, but may be configured to measure the current at the variable resistor 81. The measurement section 82 outputs a signal indicating the measured voltage to the control section 90.

The liquid level detection data may be data indicating a correspondence relationship between the voltage measured by the measurement section 82 and the liquid level L. The control section 90 calculates the liquid level L corresponding to the voltage measured by the measurement section 82 by referring to the liquid level detection data.

In this manner, the control section 90 detects the liquid level L according to the output of the sensor 63. In other words, the sensor 63 can detect the liquid level L by detecting the voltage value of the variable resistor 81 according to displacement of the second magnetic body 62 in the direction along the Z-axis.

As a specific example, the variable resistor 81 includes a slider (not illustrated). The slider is connected to the measurement section 82. A power supply voltage Vcc is applied to both end sections of the variable resistor 81. The slider is displaced between both end sections of the variable resistor 81. The slider is displaced in synchronization with the rotation angle of the rotation shaft of the link member 61.

The resistance value between the slider and the ground changes according to the position of the slider. In this manner, the potential difference between the slider and the ground changes depending on the position of the slider. That is, the potential difference between the slider and the ground changes according to the liquid level L.

The measurement section 82 measures the potential difference between the slider and the ground. In this manner, the measurement section 82 can measure the potential difference corresponding to displacement of the slider. In this way, the measurement section 82 can measure the potential difference corresponding to the rotation angle of the link member 61.

### Operations and effects of second embodiment

Operations and effects of second embodiment will be described.

(2-1) The sensor 63 has the variable resistor 81 that changes resistance value according to displacement of the second magnetic body 62 in the direction along the Z-axis, and the measurement section 82 that measures the current or voltage in the variable resistor 81.

According to this configuration, the liquid level L can be detected using the variable resistor 81. By this, it is possible to smaller size and lower cost of the sensor 63. Therefore, it is possible to smaller size and lower cost of the liquid accommodation body 21.

### THIRD EMBODIMENT

Next, a third embodiment will be described.

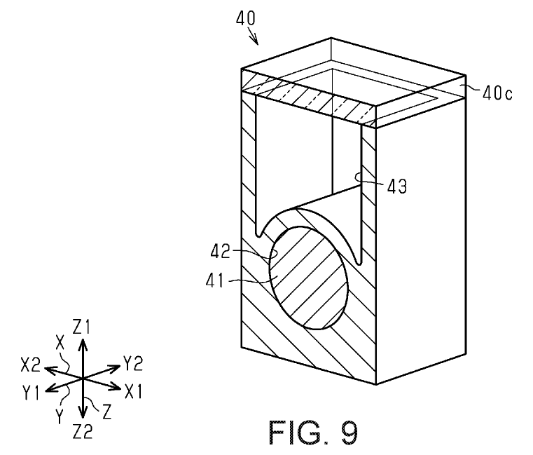

As illustrated in FIG. 9, in the third embodiment, the magnetic body accommodation chamber 42 may be provided on the lower direction Z2 than the air chamber 43. The float section 40 may be configured by the sealing lid 40c, the air chamber 43, the magnetic body accommodation chamber 42, and the first magnetic body 41 in this order from the upper direction Z1 to the lower direction Z2. That is, the float section 40 of the third embodiment has a configuration in which the float section 40 of the first embodiment and the second embodiment are vertically inverted.

### Operations and effects of third embodiment

Operations and effects of third embodiment will be described.

(3-1) The magnetic body accommodation chamber 42 is provided in the lower direction Z2 than the air chamber 43. According to this configuration, the first magnetic body 41 is provided in the lower direction Z2 than the air chamber 43, and thus the center of gravity of the float section 40 is lowered by the weight of the first magnetic body 41. By this, the float section 40 can float in a more stable state on the liquid accommodated in the liquid accommodation section 30. By this, it can increase the certainty that the float section 40 floats on the liquid accommodated in the liquid accommodation section 30. Therefore, the detection accuracy of the liquid level L can be improved.

### MODIFICATIONS

The present embodiment can be implemented with the following modifications. The embodiments and the following modifications can be implemented in combination with each other as long as there is no technical contradiction.

-In the first embodiment, the link member 61 may not slide along the longitudinal direction. The link member 61 may include a circular hole instead of the elongated hole 61c extending in the longitudinal direction. The link member 61 may include the rotation shaft and be rotatable around the rotation shaft.

-In the second embodiment, the measurement section 82 may be configured to measure the current in the variable resistor 81. The measurement section 82 may be an ammeter. As a specific example, the power supply voltage Vcc is applied between the slider and the ground. The current value flowing between the slider and the ground changes according to the position of the slider. That is, the current value flowing between the slider and the ground changes according to the liquid level L. The measurement section 82 outputs a signal indicating the measured current to the control section 90. The liquid level detection data may be data indicating a correspondence relationship between the current measured by the measurement section 82 and the liquid level L. The control section 90 calculates the liquid level L corresponding to the current measured by the measurement section 82 by referring to the liquid level detection data.

The guide section 50 may be provided in any shape and position as long as the float section 40 floats on the liquid accommodated in the liquid accommodation section 30. The guide section 50 may be in contact with the inner side surface 30b of the liquid accommodation section 30. For example, a notch may be provided on the lower direction Z2 side of the guide section 50. If the float section 40 is displaceable in the direction along the Z-axis, linked with the liquid level L, the liquid accommodation body 21 does not need to include the guide section 50.

-The float section 40 may not include the magnetic body accommodation chamber 42. The first magnetic body 41 may not be accommodated in the float section 40 as long as the first magnetic body 41 moves linked with displacement of the float section 40 in the direction along the Z-axis. That is, the float section 40 may not accommodate the first magnetic body 41.

The sealing lid 40c may be provided so as to close the air chamber 43 of the float section 40. That is, the sealing lid 40c is not limited to being provided so as to close the air chamber 43 from the lower direction Z2 of the float section 40. The sealing lid 40c may be transparent or not transparent.

The size of the opening section 40b may be adjusted as desired. The size of the opening section 40b may be, for example, a size through which the first magnetic body 41 cannot pass, and may be completely blocked. That is, the opening section 40b may not be provided. The distances between the first magnetic body 41 and the first surface 40a may be adjusted as necessary.

The link guide section 70 may include a third link guide section separately from the first link guide section 71 and the second link guide section 72. As long as the link member 61 is rotatably linked with the liquid level L, the link guide section 70 may not include either the first link guide section 71 or the second link guide section 72. If the link member 61 is rotatably linked with the liquid level L, the liquid level detection device 60 may not include the link guide section 70. The link member 61 may not rotate along the outer side surface 30a.

The support shaft 32 may be provided at any position as long as the link member 61 is rotatably linked with the liquid level L. The support shaft 32 may be directly provided in the liquid ejection device 11 instead of the liquid accommodation section 30. That is, the liquid accommodation section 30 may not include the support shaft 32.

The second magnetic body 62 may have a shape extending along the longitudinal direction of the link member 61. By this, even when the link member 61 rotates, the second magnetic body 62 can be displaced so as to face the first magnetic body 41 moving linked with displacement of the first magnetic body 41.

The liquid level detection data may be data in which the angle of the link member 61 and the liquid level L are in an inversely proportional relationship. In the liquid level detection data, the angle of the link member 61 and the liquid level L may have a curved relationship instead of a linear relationship.

The first magnetic body 41, the second magnetic body 62, and the link member 61 may be provided at any position, not on the front direction Y1 side of the liquid accommodation section 30, as long as the first magnetic body 41 and the second magnetic body 62 attract each other. That is, the first magnetic body 41 may be provided on any inner side surface 30b of the liquid accommodation section 30, and the second magnetic body 62 and the link member 61 may be provided on any outer side surface 30a of the liquid accommodation section 30.

The liquid accommodation section 30 may include a recess section (not illustrated) that is lower than a bottom surface. The recess section may be capable of accommodating the float section 40 when the float section 40 is displaced in the lower direction Z2. By this, it can expand a displacement region of the float section 40.

The liquid accommodation body 21 may include a plurality of electrodes (not illustrated) separately from the liquid level detection device 60. The plurality of electrodes are provided in the liquid accommodation section 30. The plurality of electrodes have different heights, and can detect whether or not the liquid level L is less than the threshold based on whether or not the electrodes are energized.

When the control section 90 determines that the detected liquid level L is equal to or lower than the threshold, the control section 90 may cause the display section (not illustrated) to display information indicating that the liquid in the liquid accommodation section 30 is to be replenished. When the control section 90 determines that the detected liquid level L is equal to or less than the threshold, the control section 90 may notify the user of information indicating that the liquid in the liquid accommodation section 30 is to be replenished by light or sound.

The angle of the link member 61 and the liquid level L have a predetermined correspondence relationship. Therefore, the sensor 63 outputs a signal corresponding to the angle of the link member 61 to the control section 90, but it can also be said that the sensor 63 outputs a signal corresponding to the liquid level L to the control section 90. That is, the sensor 63 detects the liquid level L corresponding to the angle of the link member 61 according to displacement of the second magnetic body 62 in the direction along the Z-axis.

The liquid level detection data may not be stored in the memory. The control section 90 may display an image related to the liquid level L on the display section based on the angle of the link member 61 based on the signal from the sensor 63.

The link member 61 may move linearly linked with displacement of the second magnetic body 62 in the direction along the Z-axis. The liquid accommodation body 21 may not use the link member 61 as long as the liquid accommodation body 21 includes a sensor that detects, in a plurality of stages, displacement of the second magnetic body 62 in the direction along the Z-axis, the second magnetic body 62 attracting the first magnetic body 41.

The liquid accommodation section 30 may be an ink tank that is directly filled with liquid, or may be provided between an ink cartridge accommodating liquid and the liquid ejection section 13. The liquid accommodation section 30 may be an ink cartridge that is attachable to and detachable from the liquid ejection device 11. In such a case, the liquid level detection device 60 may be provided in the liquid accommodation section 30 or may be provided in the liquid ejection device 11 itself. That is, in a case where the liquid accommodation section 30 is detachable, the liquid accommodation body 21 may be configured to include the liquid accommodation section 30 and the liquid level detection device 60. The liquid accommodation body 21 includes the liquid accommodation section 30, but may not include the liquid level detection device 60. In this manner, the liquid ejection device 11 may include the liquid level detection device 60, and the liquid accommodation section 30 may be attachable and detachable.

The medium may be a paper sheet, a resin film or sheet, a composite film of resin and metal, a laminate film, a woven fabric, a nonwoven fabric, a metal foil, a metal film, a ceramic sheet, clothing, or the like.

The liquid can be arbitrarily selected as long as the liquid can be printed on the medium by adhering to the medium. For example, the ink includes an ink in which particles of functional material made of solid material such as pigment or metal particles are dissolved, dispersed, or mixed in a solvent, and includes various compositions such as water-based ink, oil-based ink, gel ink, and hot-melt ink.

As used herein, the phrase "at least any" means one or more of the desired options. As an example, the phrase "at least any of" as used herein means only one option if the number of options is two, or both of the two options. As another example, the phrase "at least any" as used herein means only one option or a combination of any two or more options if the number of options is three or more.

### APPENDIX

Hereinafter, technical ideas grasped from the above-described embodiment and modifications, and operations and effects thereof will be described. The present technical idea and the operations and effects thereof can be combined with each other within a technically consistent range.

[1] A liquid accommodation body includes a liquid accommodation section configured to accommodate liquid; a float section that is provided in the liquid accommodation section and that is configured to be displaced in a vertical direction by floating in the liquid accommodated in the liquid accommodation section; a first magnetic body that is provided in the liquid accommodation section and that is configured to move linked with displacement of the float section in the vertical direction; a second magnetic body that is provided outside the liquid accommodation section and that is configured to move linked with displacement of the first magnetic body in the vertical direction; and a sensor that is provided outside the liquid accommodation section and that is configured to detect a value corresponding to a liquid level of the liquid accommodated in the liquid accommodation section according to displacement of the second magnetic body in the vertical direction.

According to this configuration, using the first magnetic body inside the liquid accommodation section, and the second magnetic body and the sensor outside the liquid accommodation section, it is possible to continuously detect displacement of the float section floating on the liquid accommodated in the liquid accommodation section in the vertical direction. By this, it is possible to continuously detect a value corresponding to the liquid level of the liquid accommodated in the liquid accommodation section. Therefore, it is possible to improve user convenience.

In addition, the float section and the first magnetic body provided inside the liquid accommodation section, and the second magnetic body and the sensor provided outside the liquid accommodation section can be linked in a non-contact manner. By this, it is possible to continuously detect a value corresponding to the liquid level of the liquid accommodated in the liquid accommodation section without providing a sensor in the liquid accommodation section. Therefore, it is possible to improve user convenience.

[2] In the liquid accommodation body may further include a link member configured to rotate according to displacement of the second magnetic body in the vertical direction.

According to this configuration, further using the link member, it continuously detects displacement of the float section floating on the liquid accommodated in the liquid accommodation section in the vertical direction. By this, it is possible to continuously detect a value corresponding to the liquid level of the liquid accommodated in the liquid accommodation section. Therefore, it is possible to improve user convenience.

[3] In the liquid accommodation body may be such that the link member is provided on an outer side surface of the liquid accommodation section.

According to this configuration, using the link member outside the liquid accommodation section, it is possible to continuously detect displacement of the float section floating on the liquid accommodated in the liquid accommodation section in the vertical direction. By this, it is possible to continuously detect a value corresponding to the liquid level of the liquid accommodated in the liquid accommodation section. Therefore, it is possible to improve user convenience.

[4] In the liquid accommodation body may such that the sensor and the second magnetic body are connected by the link member and an angle of the link member changes according to displacement of the second magnetic body in the vertical direction.

According to this configuration, displacement of the float section in the vertical direction can be detected based on the angle of the link member. By this, it is possible to continuously detect a value corresponding to the liquid level of the liquid accommodated in the liquid accommodation section without providing a sensor in the liquid accommodation section. Therefore, it is possible to improve user convenience.

[5] In the liquid accommodation body may such that the sensor is an angle sensor that changes output according to a change in the angle of the link member. According to this configuration, the same effect as that of [4] can be achieved.

[6] In the liquid accommodation body may such that the sensor has a variable resistor that changes resistance value according to displacement of the second magnetic body in the vertical direction, and a measurement section configured to measure a current or a voltage in the variable resistor.

According to this configuration, using the variable resistor, it is possible to continuously detect a value corresponding to the liquid level. By this, it is possible to smaller size and lower cost of the sensor. Therefore, it is possible to smaller size and lower cost of the liquid accommodation body.

[7] In the liquid accommodation body may such that the float section has a magnetic body accommodation chamber configured to accommodate the first magnetic body and an air chamber and the magnetic body accommodation chamber and the air chamber are provided at positions overlapping each other as viewed from the vertical direction.

According to this configuration, with a simple configuration, the float section can float in a more stable state on the liquid accommodated in the liquid accommodation section while the first magnetic body is accommodated. By this, it can increase the certainty that the float section floats on the liquid accommodated in the liquid accommodation section. Therefore, the detection accuracy of the value corresponding to the liquid level can be improved.

[8] In the liquid accommodation body may such that the magnetic body accommodation chamber is provided further in an upper direction than the air chamber.

According to this configuration, the same effect as that of [7] can be achieved.

[9] In the liquid accommodation body may such that the magnetic body accommodation chamber is provided further in a lower direction than the air chamber.

According to this configuration, the same effect as that of [7] can be achieved.

[10] In the liquid accommodation body may such that the liquid accommodation section has a guide section configured to guide the float section so as to be displaceable in the vertical direction.

According to this configuration, it can increase the certainty of displacing the float section in the vertical direction. By this, the float section can float in a more stable state on the liquid accommodated in the liquid accommodation section. Therefore, the detection accuracy of the value corresponding to the liquid level can be improved.

[11] A liquid ejection device configured to detect a liquid level of a liquid accommodated in a liquid accommodation body including a liquid accommodation section configured to accommodate the liquid, a float section configured to float on the liquid accommodated in the liquid accommodation section and to be displaced in a vertical direction, and a first magnetic body configured to move linked with displacement of the float section in the vertical direction, the liquid ejection device includes a liquid ejection section configured to eject the liquid accommodated in the liquid accommodation body; a second magnetic body configured to move linked with displacement of the first magnetic body in the vertical direction; a sensor configured to detect a value corresponding to the liquid level of the liquid accommodated in the liquid accommodation body according to displacement of the second magnetic body in the vertical direction; and a control section configured to calculate the liquid level of the liquid accommodated in the liquid accommodation section based on a detection result of the sensor.

According to this configuration, the same effect as that of [1] can be achieved.

What is claimed is:

1. A liquid accommodation body comprising:
a liquid accommodation section configured to accommodate liquid;
a float section that is provided in the liquid accommodation section and that is configured to be displaced in a vertical direction by floating in the liquid accommodated in the liquid accommodation section;
a first magnetic body that is provided in the liquid accommodation section and that is configured to move linked with displacement of the float section in the vertical direction;
a second magnetic body that is provided outside the liquid accommodation section and that is configured to move linked with displacement of the first magnetic body in the vertical direction; and
a sensor that is provided outside the liquid accommodation section and that is configured to detect a value corresponding to a liquid level of the liquid accommodated in the liquid accommodation section according to displacement of the second magnetic body in the vertical direction.

2. The liquid accommodation body according to claim 1, further comprising:
a link member configured to rotate according to displacement of the second magnetic body in the vertical direction.

3. The liquid accommodation body according to claim 2, wherein
the link member is provided on an outer side surface of the liquid accommodation section.

4. The liquid accommodation body according to claim 2, wherein
the sensor and the second magnetic body are connected by the link member and
an angle of the link member changes according to displacement of the second magnetic body in the vertical direction.

5. The liquid accommodation body according to claim 4, wherein
the sensor is an angle sensor that changes output according to a change in the angle of the link member.

6. The liquid accommodation body according to claim 1, wherein
the sensor has a variable resistor that changes resistance value according to displacement of the second magnetic body in the vertical direction, and a measurement section configured to measure a current or a voltage in the variable resistor.

7. The liquid accommodation body according to claim 1, wherein
the float section has a magnetic body accommodation chamber configured to accommodate the first magnetic body and an air chamber and
the magnetic body accommodation chamber and the air chamber are provided at positions overlapping each other as viewed from the vertical direction.

8. The liquid accommodation body according to claim 7, wherein
the magnetic body accommodation chamber is provided further in an upper direction than the air chamber.

9. The liquid accommodation body according to claim 7, wherein
the magnetic body accommodation chamber is provided further in a lower direction than the air chamber.

10. The liquid accommodation body according to claim 1, wherein
the liquid accommodation section has a guide section configured to guide the float section so as to be displaceable in the vertical direction.

11. A liquid ejection device configured to detect a liquid level of liquid accommodated in a liquid accommodation body including a liquid accommodation section configured to accommodate the liquid, a float section configured to be displaced in a vertical direction by floating in the liquid accommodated in the liquid accommodation section, and a first magnetic body configured to move linked with displacement of the float section in the vertical direction, the liquid ejection device comprising:
a liquid ejection section configured to eject the liquid accommodated in the liquid accommodation body;
a second magnetic body configured to move linked with displacement of the first magnetic body in the vertical direction;
a sensor configured to detect a value corresponding to the liquid level of the liquid accommodated in the liquid accommodation body according to displacement of the second magnetic body in the vertical direction; and
a control section configured to calculate the liquid level of the liquid accommodated in the liquid accommodation section based on a detection result of the sensor.

12. A liquid ejection device comprising:
an ink tank configured to accommodate ink;
a liquid ejection section configured to eject the ink accommodated in the ink tank;
a float section that is provided in the ink tank and that is configured to float in the liquid accommodated in the ink tank and to be displaced;
a first magnetic body that is provided in the liquid accommodation section and that is configured to move linked with displacement of the float section;
an angle sensor that is provided on an outer side surface of the liquid accommodation section and that is configured to detect a displacement of the first magnetic body; and
a control section configured to calculate the liquid level of the ink accommodated in the ink tank based on a detection result of the angle sensor.
